(19) United States
(12) Patent Application Publication
(10) Pub. No.: US 2022/0165999 A1
(43) Pub. Date: May 26, 2022

(54) Method of Producing Electrode for All-Solid-State Battery with Improved Adhesive Strength

(71) Applicants: Hyundai Motor Company, Seoul (KR); Kia Corporation, Seoul (KR)

(72) Inventors: Tae Young Kwon, Daegu (KR); Gyeong Jun Chung, Daejeon (KR); Ju Yeon Lee, Busan (KR); Sung Hoo Jung, Changwon-si (KR); Sang Mo Kim, Hwaseong-si (KR); Hoon Seok, Suwon-si (KR)

(21) Appl. No.: 17/376,743

(22) Filed: Jul. 15, 2021

(30) Foreign Application Priority Data
Nov. 23, 2020 (KR) 10-2020-0157334

(51) Int. Cl. H01M 4/04; H01M 10/0525; H01M 4/62

(52) U.S. Cl. CPC H01M 4/0404; H01M 2004/021; H01M 4/622; H01M 10/0525

(57) ABSTRACT

A method of producing an electrode includes applying a binder solution comprising a first binder onto a substrate to form an undried adhesive layer, applying an electrode solution comprising an electrode active material and a second binder onto the undried adhesive layer to form an active material layer, and drying the undried adhesive layer and the active material layer.

### CROSS-REFERENCE TO RELATED APPLICATIONS

This application claims the benefit of Korean Patent Application No. 10-2020-0157334, filed on Nov. 23, 2020, which application is hereby incorporated herein by reference.

### TECHNICAL FIELD

The present invention relates to a method of producing an electrode for an all-solid-state battery with improved adhesive strength.

### BACKGROUND

Industrial development has brought about an increase in the demand for batteries with high energy density. Accordingly, research has been actively conducted on an all-solid-state battery including a cathode, an anode and a solid electrolyte layer disposed between the cathode and the anode. However, unlike conventional lithium-ion batteries, all-solid-state batteries require the addition of a solid electrolyte to the electrode, making it difficult to thicken the electrode.

The adhesive strength of the electrode, particularly the binder in the electrode, is an important factor for solving this problem. The binder can improve the adhesive strength between two materials in the electrode and the adhesive strength between the electrode and the current collector, but may directly affect battery performance, since it is a resistor. Efficient use of a binder is essential for thickening the electrode and realizing high energy density.

Conventionally, an electrode is manufactured by adding an active material, a binder and the like to a solvent and applying the resulting mixture to a current collector, followed by drying. In this case, during the drying process, the solvent is evaporated, and at the same time, the binder moves in the direction of evaporation of the solvent, that is, to the upper side of the electrode, thus resulting in easy detachment between the electrode and the current collector.

Insufficient adhesive strength to the electrode of the all-solid-state battery causes an increase in the resistance of the electrode removed from the current collector and difficulty in increasing the amount of the active material that can be loaded thereon. In addition, this may make an assembly process impossible due to detachment of the electrode, decrease processing speed, and cause stability problems due to short circuiting of the battery.

The above information disclosed in this Background section is only for enhancement of understanding of the background of the invention, and therefore it may contain information that does not form the prior art that is already known to a person of ordinary skill in the art.

### SUMMARY

Embodiments of the present invention can solve problems associated with the prior art, and an embodiment of the present invention provides a method of producing an electrode for an all-solid-state battery having excellent adhesion between materials in the electrode and excellent adhesion between the electrode and a current collector.

The embodiments of the present invention are not limited to those described above. Other embodiments of the present invention will be clearly understood from the following description, and are able to be implemented by means defined in the claims and combinations thereof.

One embodiment of the present invention provides a method of producing an electrode for an all-solid-state battery including applying a binder solution containing a first binder onto a substrate to form an adhesive layer, applying an electrode solution containing an electrode active material and a second binder onto the undried adhesive layer to form an active material layer, and drying the adhesive layer and the active material layer.

The first binder may include at least one selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and a combination thereof.

The binder solution may have a viscosity of 5,000 cp to 10,000 cp.

The second binder may include at least one selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and a combination thereof.

The electrode solution may have a viscosity of 5,000 cp to 10,000 cp.

A thickness ratio of the adhesive layer to the active material layer may be 1:1 to 1:20.

The forming an adhesive layer and the forming an active material layer may be repeatedly performed before the drying.

The drying may be performed at 80 to 120° C.

The drying may be performed for 10 minutes to 2 hours.

Material exchange may occur between the undried adhesive layer and the active material layer during the drying to cause an interlayer boundary to disappear.

Other aspects and preferred embodiments of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1 is a flowchart showing a method of producing an electrode for an all-solid-state battery according to embodiments of the present invention;

FIG. 2A shows a step of forming an adhesive layer according to an embodiment of the present invention;

FIG. 2B shows a step of forming an active material layer according to an embodiment of the present invention;

FIG. 2C shows a step of drying according to an embodiment of the present invention;

FIG. 2D shows an electrode produced according to an embodiment of the present invention.

FIG. 3A shows a step of forming an adhesive layer according to another embodiment of the present invention;

FIG. 3B shows a step of forming an active material layer according to another embodiment of the present invention;

FIG. 3C shows a step of drying according to another embodiment of the present invention;

FIG. 3D shows an electrode produced according to another embodiment of the present invention;

FIG. 4A shows a result of scanning electron microscope (SEM) analysis of an electrode for an all-solid-state battery according to a Comparative Example; and

FIG. 4B shows a result of scanning electron microscope (SEM) analysis of an electrode for an all-solid-state battery according to an Example.

### DETAILED DESCRIPTION OF ILLUSTRATIVE EMBODIMENTS

The embodiments described above, as well as other objects, features and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum including the maximum within the range, unless otherwise defined.

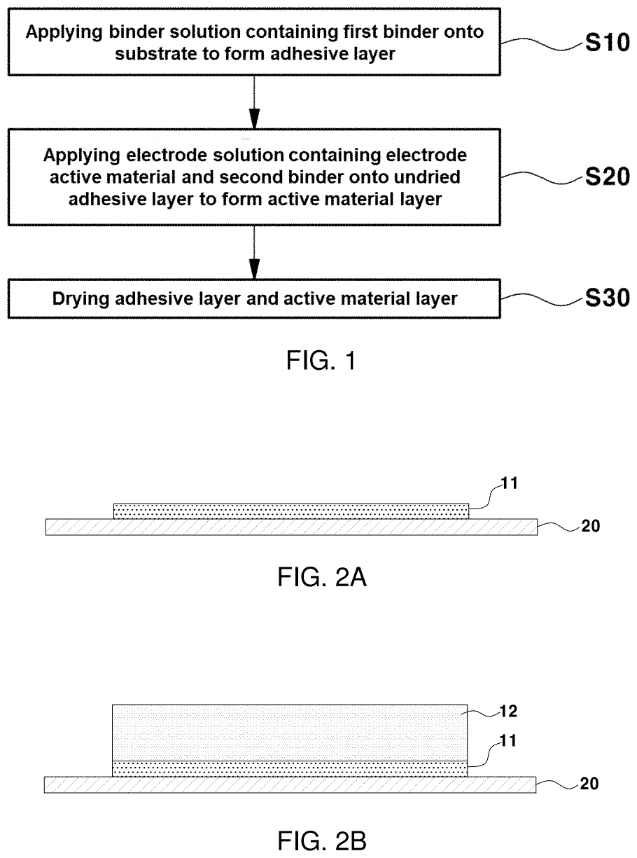

FIG. 1 is a flowchart showing a method of producing an electrode for an all-solid-state battery according to embodiments of the present invention. Referring to FIG. 1, the method includes applying a binder solution containing a first binder onto a substrate to form an adhesive layer (S10), applying an electrode solution containing an electrode active material and a second binder onto the undried adhesive layer to form an active material layer (S20), and drying the adhesive layer and the active material layer (S30).

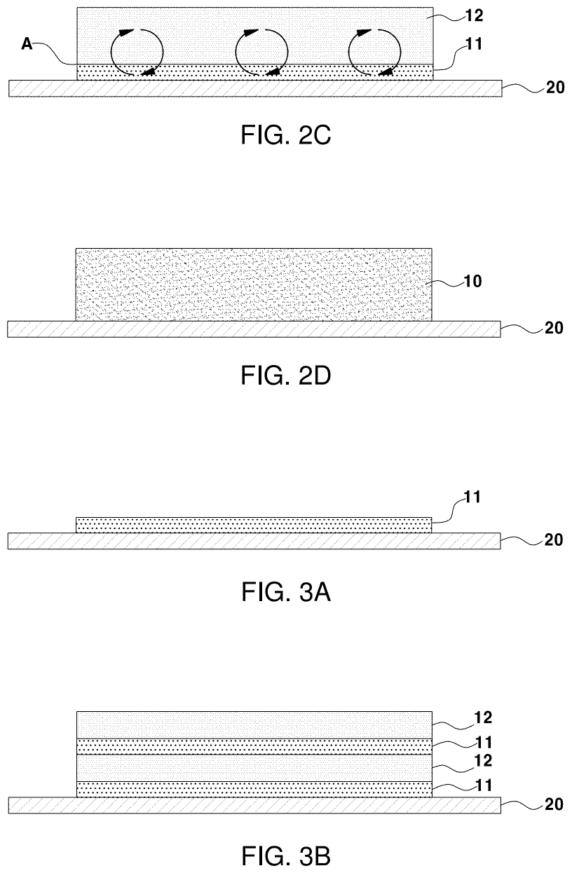

FIG. 2A shows a step of forming the adhesive layer (S10). The adhesive layer 11 may be formed by applying the binder solution onto the substrate 20.

The substrate 20 may include a current collector, and the current collector may be an anode current collector or a cathode current collector.

The anode current collector may be a plate-shaped substrate having electrical conductivity. The anode current collector may include at least one selected from the group consisting of nickel (Ni), stainless steel (SUS), and a combination thereof.

The cathode current collector may be a plate-shaped substrate having electrical conductivity. The cathode current collector may include aluminum foil.

The binder solution may include a first binder and a solvent.

The first binder may include at least one selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and a combination thereof.

The solvent may include at least one selected from the group consisting of butylate, toluene, xylene, anisole, hexane, heptane, dibromomethane, dichloroethane, dichlorohexane, ethanol, glycol ether and a combination thereof.

The binder solution may have a viscosity of 5,000 cp to 10,000 cp, or 5,000 cp to 6,000 cp. When the viscosity of the binder solution is less than 5,000 cp, there may be a difficulty in producing a thick layer electrode, and when the viscosity exceeds 10,000 cp, there may be a problem in that the resistance of the cell is increased due to insufficient material exchange between the adhesive layer and the active material layer.

FIG. 2B shows a step of forming the active material layer (S20).

In embodiments of the present invention, the electrode solution is applied onto the adhesive layer 11 to form the active material layer 12, wherein the electrode solution is applied in the state in which the adhesive layer 11 is not dried. When the active material layer 12 is formed in the state in which the adhesive layer 11 is completely dried, material exchange between the two layers 11 and 12 does not occur in the drying step, which will be described later, and thus adhesive strength cannot be improved. In addition, when the adhesive layer 11 exists as a separate layer on the final electrode, it acts as a resistor, thus resulting in poor battery performance.

As used herein, the term “undried state” means a state in which 70% by weight or more, or 80% by weight or more, or 90% by weight or more, or 99% by weight or more of the solvent constituting the adhesive layer 11 remains.

The electrode solution may be applied to the adhesive layer 11 immediately after the adhesive layer 11 is formed in order to apply the electrode solution to the undried adhesive layer 11. However, the present invention is not limited thereto, and the electrode solution may be applied to the adhesive layer 11, even after the lapse of time, after the adhesive layer 11 may be stored in a chamber in a humidified or dry atmosphere, or may be moved through the chamber.

The electrode solution may include an electrode active material, a solid electrolyte, a second binder, and a solvent.

The electrode active material may include a cathode active material or an anode active material.

The cathode active material may be an oxide active material or a sulfide active material.

The oxide active material may be a rock-salt-layer-type active material such as LiCoO₂, LiMnO₂, LiNiO₂, LiVO₂, or Li₁₊ₓNi_{1/3}Co_{1/3}Mn_{1/3}O₂, a spinel-type active material such as LiMn₂O₄ and Li(Ni_{0.5}Mn_{1.5}O₄, a reverse-spinel-type active material such as LiNiVO₄ or LiCoVO₄, an olivine-type active material such as LiFePO₄, LiMnPO₄, LiCoPO₄, or LiNiPO₄, a silicon-containing active material such as Li₂FeSiO₄ or Li₂MnSiO₄, a rock-salt-layer-type active material having a transition metal, a part of which is substituted with a heterogeneous metal such as LiNi_{0.8}Co_{(0.2-x)}AlₓO₂ (0<x<0.2), a spinel-type active material having a transition metal, a part of which is substituted with a heterogeneous metal such as Li₁₊ₓMn_{2-x-y}M_{y}O₄ (wherein M includes at least one of Al, Mg, Co, Fe, Ni, Zn, and 0<x+y<2), and a lithium titanate such as Li₄Ti₅O₁₂.

The sulfide active material may be copper Chevrel, iron sulfide, cobalt sulfide, nickel sulfide, or the like.

The anode active material may be a carbon active material or a metal active material.

The carbon active material may be graphite such as mesocarbon microbeads (MCMB) or highly oriented pyrolytic graphite (HOPG), or amorphous carbon such as hard carbon or soft carbon.

The metal active material may be In, Al, Si, Sn, an alloy containing at least one of these elements, or the like.

The solid electrolyte may be an oxide solid electrolyte or a sulfide solid electrolyte. However, preferred is the use of a sulfide solid electrolyte having high lithium ion conductivity.

The sulfide solid electrolyte may be Li₂S—P₂S₅, Li₂S—P₂S₅—LiI, Li₂S—P₂S₅S—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂ or the like.

The second binder may include at least one selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and a combination thereof. The second binder may be the same as or different from the first binder.

The solvent may include at least one selected from the group consisting of butylate, toluene, xylene, anisole, hexane, heptane, dibromomethane, dichloroethane, dichlorohexane, ethanol, glycol ether and a combination thereof.

The electrode solution may have a viscosity of 5,000 cp to 10,000 cp, or 5,000 cp to 6,000 cp. The viscosity of the electrode solution may be the same as or similar to that of the binder solution. Conventionally, an active material layer is produced by applying an electrode slurry including an electrode active material, a solid electrolyte, a binder and the like, followed by drying. In embodiments of the present invention, the active material layer is produced using an electrode solution having lower viscosity due to the high solvent content and low binder content thereof compared to the electrode slurry. Accordingly, material exchange may be smoothly performed between the adhesive layer 11 and the active material layer 12 during drying, which will be described later.

The thickness ratio of the adhesive layer 11 to the active material layer 12 may be 1:1 to 1:20. The adhesive layer 11 is in an undried state at this thickness ratio. When the thickness ratio is less than 1:1, there may be problems in that material exchange between the adhesive layer and the active material layer may be impeded and the resistance of the cell may increase. When the ratio exceeds 1:20, there may be a problem in that the adhesive strength of the thick layer electrode is insufficient.

FIG. 2C shows a step of drying the adhesive layer and the active material layer (S30).

Through the drying process, material exchange occurs between the undried adhesive layer 11 and the active material layer 12, thus causing the interlayer boundary A to disappear and resulting in formation of the electrode 10 as shown in FIG. 2D. Material exchange occurs between the two layers 11 and 12, thus making the distribution of the first and second binders uniform and greatly improving the adhesive strength within the electrode 10 and the adhesive strength between the electrode 10 and the substrate 20.

In embodiments of the present invention, drying is performed under mild conditions so that material exchange between the adhesive layer ii and the active material layer 12 is sufficiently performed. Specifically, the drying may be performed at a temperature of 80° C. to 120° C. for 10 minutes to 2 hours.

The electrode 10 of FIG. 2D may be a thick layer having a thickness of 100 μm to 300 μm.

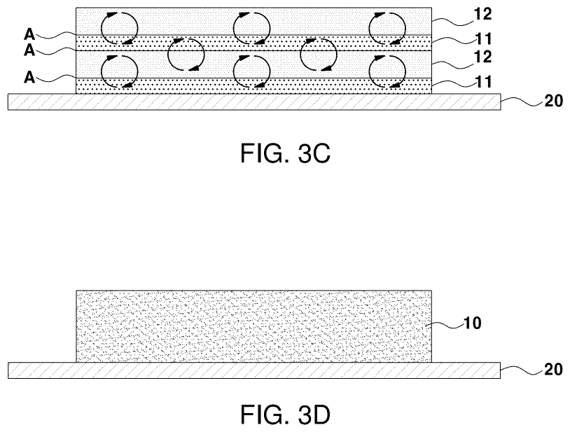

FIGS. 3A to 3D show a method of producing an electrode for an all-solid-state battery according to another embodiment of the present invention.

FIG. 3A shows applying a binder solution onto a substrate 20 to form the adhesive layer 11, as described above.

Next, as shown in FIG. 3B, an electrode solution is applied onto the undried adhesive layer 11 to form the active material layer 12, and another adhesive layer ii and another active material layer 12 are formed thereon. The adhesive strength of the electrode produced in a subsequent step can be further improved by repeatedly performing the step of forming the adhesive layer and the step of forming the active material layer as described above.

FIG. 3C shows that a structure including a plurality of adhesive layers 11 and a plurality of active material layers 12 which are repeatedly stacked is dried and material exchange occurs between the layers 11 and 12. As a result, an electrode 10 having improved adhesive strength can be formed, as shown in FIG. 3D.

Hereinafter, embodiments of the present invention will be described in more detail with reference to specific examples. However, the following examples are provided only for better understanding of embodiments of the present invention, and thus should not be construed as limiting the scope of the present invention.

### EXAMPLE

A binder solution having a viscosity of about 5,000 cp to 6,000 cp was applied onto a substrate to form an adhesive layer.

An electrode solution having a viscosity of about 5,000 cp to about 6,000 cp and containing an electrode active material, a solid electrolyte and a binder was applied to an undried adhesive layer to form an active material layer. At this time, the thickness ratio of the adhesive layer and the active material layer was adjusted to 1:10.

The adhesive layer and the active material layer were dried at about 90° C. for about 15 minutes to produce an electrode.

### Comparative Example

An electrode active material, a solid electrolyte and a binder were weighed and prepared such that the constituent components and contents of the finally produced electrode were the same as in the Example described above, and were then formed into a slurry.

The slurry was applied onto a substrate, followed by drying, to produce an electrode having the same thickness as in the Example described above.

### Experimental Example 1

Scanning electron microscope (SEM) analysis was performed on the electrodes according to the Example and the Comparative Example.

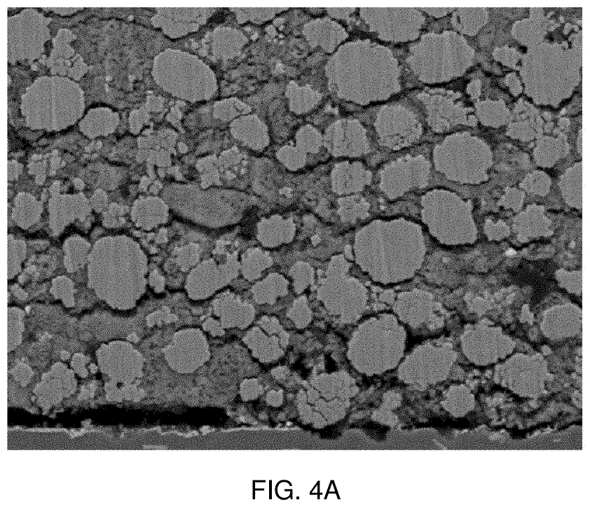

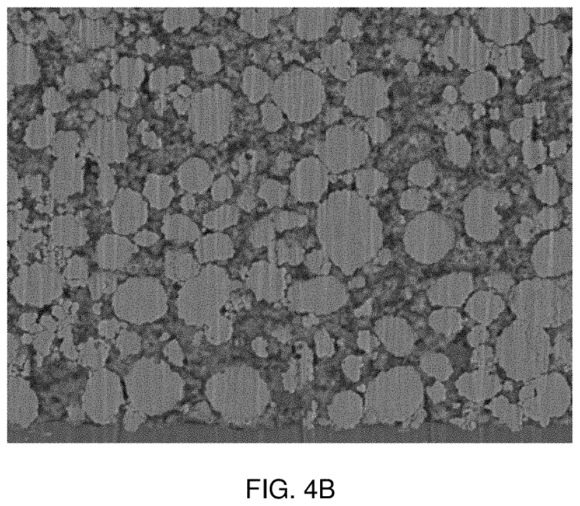

FIG. 4A shows a result of analysis of an electrode according to the Comparative Example. As can be seen from FIG. 4A, there are many cracks in the electrode, and in particular, detachment occurs in a part where the electrode contacts a substrate at a lower side.

FIG. 4B shows a result of analysis of an electrode according to the Example. As can be seen from FIG. 4B, the electrode was very dense and did not crack, and no detachment occurred in a part where the electrode contacted a substrate at a lower side.

### Experimental Example 2

The adhesive strength of the electrodes according to the Example and the Comparative Example was evaluated. Tensile strength was measured at a speed of 30 mm/min in a horizontal direction using a universal testing machine (UTM). The electrode according to the Comparative Example had an adhesive strength of about 0.5 gf/mm, whereas the electrode according to the Example had an adhesive strength of about 10 gf/mm, which was an improvement of about 20 times.

According to embodiments of the present invention, an electrode for an all-solid-state battery having improved adhesive strength can be obtained. As a result, the electrode can be produced as a thick layer, and thus an all-solid-state battery having high energy density can be obtained.

The effects of embodiments of the present invention are not limited to those mentioned above. It should be understood that the effects of embodiments of the present invention include all effects that can be inferred from the description of embodiments of the present invention.

Although Experimental Examples and an Example of embodiments of the present invention have been described in detail, they should not be construed as limiting the scope of the present invention. Those skilled in the art will appreciate that various modifications, additions and substitutions are possible, without departing from the scope and spirit of the invention as disclosed in the accompanying claims.

What is claimed is:

1. A method of producing an electrode, the method comprising:
applying a binder solution containing a first binder onto a substrate to form an undried adhesive layer;
applying an electrode solution containing an electrode active material and a second binder onto the undried adhesive layer to form an active material layer; and
drying the undried adhesive layer and the active material layer.

2. The method according to claim 1, wherein the first binder comprises at least one binder selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and combinations thereof.

3. The method according to claim 1, wherein the binder solution has a viscosity of 5,000 cp to 10,000 cp.

4. The method according to claim 1, wherein the second binder comprises at least one binder selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and combinations thereof.

5. The method according to claim 1, wherein the electrode solution has a viscosity of 5,000 cp to 10,000 cp.

6. The method according to claim 1, wherein a thickness ratio of the undried adhesive layer to the active material layer is 1:1 to 1:20.

7. The method according to claim 1, wherein forming the undried adhesive layer and forming the active material layer are repeatedly performed before the drying.

8. The method according to claim 1, wherein the drying is performed at 80 to 120° C.

9. The method according to claim 1, wherein the drying is performed for 10 minutes to 2 hours.

10. The method according to claim 1, wherein material exchange occurs between the undried adhesive layer and the active material layer during the drying to cause an interlayer boundary to disappear. ii. A method of producing an electrode for an all-solid-state battery, the method comprising:
forming an undried adhesive layer by applying a binder solution comprising a first binder and a solvent onto a current collector;
forming an active material layer on the undried adhesive layer by applying an electrode solution comprising an electrode active material and a second binder onto the undried adhesive layer; and
drying the undried adhesive layer and the active material layer, wherein material exchange occurs between the undried adhesive layer and the active material layer during the drying to produce the electrode.

12. The method according to claim 11, wherein the first binder comprises at least one selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and combinations thereof.

13. The method according to claim 12, wherein the solvent comprises at least one selected from the group consisting of butylate, toluene, xylene, anisole, hexane, heptane, dibromomethane, dichloroethane, dichlorohexane, ethanol, glycol ether, and combinations thereof.

14. The method according to claim 13, wherein the binder solution has a viscosity of 5,000 cp to 10,000 cp.

15. The method according to claim 11, wherein the second binder comprises at least one selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), and combinations thereof.

16. The method according to claim 11, wherein the electrode solution further comprises a solid electrolyte and a second solvent.

17. The method according to claim 11, wherein the electrode solution has a viscosity of 5,000 cp to 10,000 cp.

18. The method according to claim 11, wherein a thickness ratio of the undried adhesive layer to the active material layer is 1:1 to 1:20.

19. The method according to claim 11, wherein the drying is performed at a temperature of 80 to 120° C. for a time period of 10 minutes to 2 hours.

20. The method according to claim 11, wherein the first binder and the second binder are the same.
